(19) United States
(12) Patent Application Publication
(10) Pub. No.: US 2025/0031729 A1
(43) Pub. Date: Jan. 30, 2025

(54) OVEN APPLIANCES AND METHODS FOR VARIABLE STATE PREDICTIONS

(71) Applicant: Haier US Appliance Solutions, Inc., Wilmington, DE (US)

(72) Inventor: Sarah Virginia Morris, Louisville, KY (US)

(21) Appl. No.: 18/357,337

(22) Filed: Jul. 24, 2023

(51) Int. Cl. A23L 5/10; F24C 3/12; F24C 7/08; H04N 7/18

(52) U.S. Cl. CPC A23L 5/15; F24C 3/128; F24C 7/087; H04N 7/18

(57) ABSTRACT

An oven appliance may include a cabinet, a heating element, a sensing element, and a controller. The cabinet may define a cooking chamber. The heating element may be in thermal communication with the cooking chamber to heat a cooking utensil therein. The sensing element may be mounted to the cabinet. The controller may be in operable communication with the heating element and the sensing element. The controller may be configured to direct a cooking operation that includes receiving a sensor signal from the sensing element, transmitting the sensor signal from the controller for determination of an off-board predicted state of the oven appliance, calculating, at the oven appliance, an on-board predicted state for a future time point, the future time point being based on a communication lag interval.

### FIELD OF THE DISCLOSURE

The present subject matter relates generally to domestic appliance, such as oven appliances, and more particularly to systems and methods for selectively operating the same.

### BACKGROUND OF THE DISCLOSURE

Domestic appliances, such as ovens, microwaves, washing machines, dryers, or dishwashers, typically include a cabinet that defines a treatment chamber for affecting one or more items therein. This may include food to be cooked, clothing items to be washed or dried, or utensils to be washed. Oven appliances in particular generally include a cabinet that defines a cooking chamber for cooking food items therein, such as by baking or broiling the food items. In order to perform the cooking operation, oven appliances typically include one or more heat sources, or heating elements, provided in various locations within the cabinet or cooking chamber. These heat sources may be used together or individually to perform various specific appliance or cooking operations, such as baking, broiling, roasting, and the like.

Increasingly, attempts are being made to use one or more advanced algorithms or programs to help execute appliance operations. For instance, advanced algorithms may take one or more detected conditions at an oven appliance and use those to more accurately estimate when a food item will reach a desired cooking state. Although helpful, such advanced algorithms may require more resources (e.g., processing power) than is available locally (i.e., on the appliance itself). As a result, the appliance may communicate detected conditions to a separate remote device on which the advanced algorithms are actually executed. This may create additional problems, however. For instance, a certain amount of lag or delay may develop between when detected conditions are transmitted to the remote device and when the algorithm results are received. In that lag time, the items within the appliance may meet or even exceed their desired state. In the case of an oven appliance, a food item may, thus, be overcooked, potentially ruining the food item and negating the intended benefit of using the advanced algorithms.

As a result, there is a need for a domestic appliance capable of addressing or accounting for lag in communications with a remote device (e.g., while still being able to make use of the increased accuracy or other benefits offered by the remote device).

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, an oven appliance is provided. The oven appliance may include a cabinet, a heating element, a sensing element, and a controller. The cabinet may define a cooking chamber. The heating element may be in thermal communication with the cooking chamber to heat a cooking utensil therein. The sensing element may be mounted to the cabinet. The controller may be in operable communication with the heating element and the sensing element. The controller may be configured to direct a cooking operation that includes receiving a sensor signal from the sensing element, transmitting the sensor signal from the controller for determination of an off-board predicted state of the oven appliance, calculating, at the oven appliance, an on-board predicted state for a future time point, the future time point being based on a communication lag interval, and directing the oven appliance based on the on-board predicted state.

In another exemplary aspect of the present disclosure, a method of operating an oven appliance is provided. The method may include receiving a sensor signal from a sensing element and transmitting the sensor signal from the oven appliance for determination of an off-board predicted state of the oven appliance. The method may also include calculating, at the oven appliance, an on-board predicted state for a future time point. The future time point may be based on a communication lag interval. The method may further include directing the oven appliance at the user interface panel or the heating element based on the on-board predicted state.

In yet another exemplary aspect of the present disclosure, a method of operating a domestic appliance is provided. The method may include receiving a sensor signal from the sensing element and transmitting the sensor signal from the domestic appliance for determination of an off-board predicted state of the domestic appliance. The method may also include calculating, at the domestic appliance, an on-board predicted state for a future time point. The future time point may be based on a communication lag interval. The method may further include directing the domestic appliance based on the on-board predicted state. The method may still further include receiving the off-board predicted state of the domestic appliance from a remote device following directing domestic oven appliance based on the on-board predicted state, and directing the domestic appliance based on the received off-board predicted state.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a domestic, oven appliance according to exemplary embodiments of the present disclosure.

FIG. 2 provides a side, cross sectional view of the exemplary oven appliance of FIG. 1 in communication with a remote device.

FIG. 3 provides a schematic view of a system for engaging a cooking appliance according to exemplary embodiments of the present disclosure.

FIG. 4 a flow chart illustrating a method of operating a domestic appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. Terms such as “inner” and “outer” refer to relative directions with respect to the interior and exterior of the oven appliance, and in particular the chamber(s) defined therein. For example, “inner” or “inward” refers to the direction towards the interior of the oven appliance. Terms such as “left,” “right,” “front,” “back,” “top,” or “bottom” are used with reference to the perspective of a user accessing the appliance (e.g., when the door is in the closed position). For example, a user stands in front of the appliance to open a door and reaches into the cooking chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise, or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments described herein may include an appliance, such as an oven appliance, or method for automatically (e.g., without direct user intervention or action) detecting changes within the appliance. For instance, an article within the appliance, such as a food item, clothing item, or utensil, may be monitored to detect changes over time. Sensors may be used to detect these changes or determine when the article reaches a desired state (e.g., of cooking, of washing, of drying, etc.). Moreover, the sensed conditions or changes may be transmitted to another device where advanced algorithms may evaluate the sensed conditions, such as to predict when the article is done cooking, being cleaned, or being dried. The results may be communicated and received by the appliance. Conditions may be repeatedly detected and communicated, such that predicts are regularly updated using the results obtained from the separate device. As the appliance awaits the results from the separate device, the appliance may locally (e.g., at a controller on the appliance) make predictions. Such predictions may be based on the detected conditions, previously received results from the separate device, or less resource-intensive calculations. In turn, a user may be able to avoid exceeding a desired state of the article within the appliance.

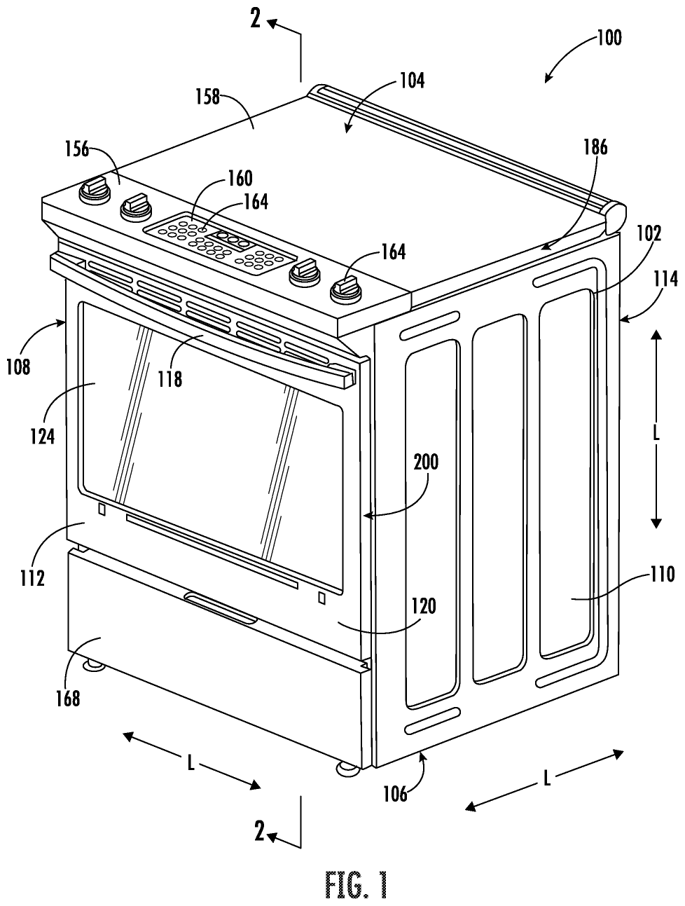

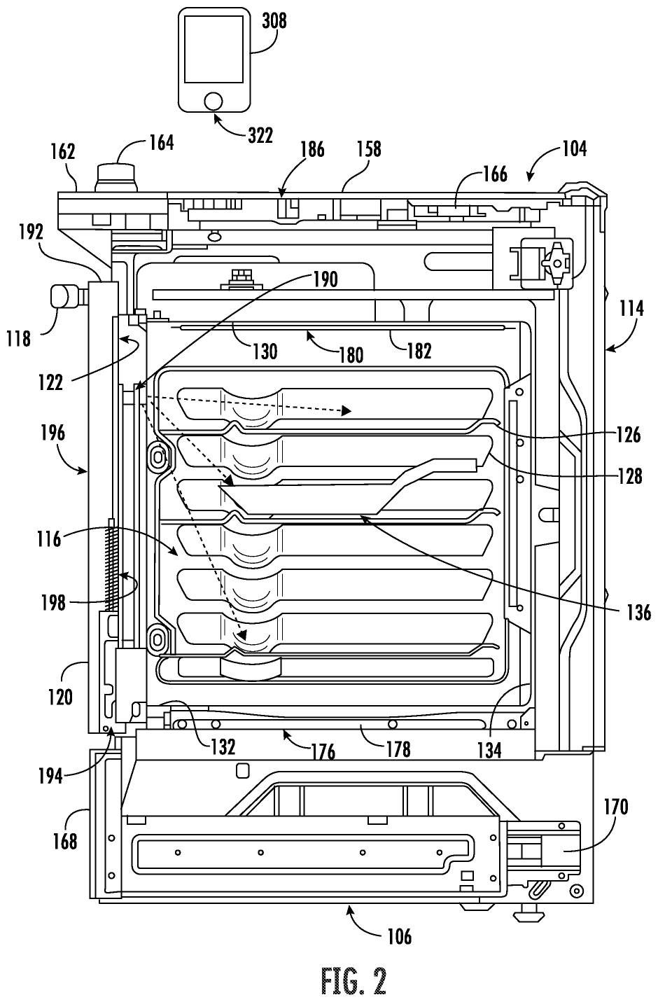

Referring now to the figures, an exemplary domestic appliance will be described in accordance with exemplary aspects of the present subject matter. Specifically, FIG. 1 provides a perspective view of an exemplary oven appliance 100 and FIG. 2 provides a side cross-sectional view of oven appliance 100. As illustrated, oven appliance 100 generally defines a vertical direction V, a lateral direction L, and a transverse direction T, each of which is mutually perpendicular, such that an orthogonal coordinate system is generally defined.

According to exemplary embodiments, oven appliance 100 includes a cabinet 102 that is generally configured for containing or supporting various components of oven appliance 100 and which may also define one or more cooking chambers or compartments of oven appliance 100. In this regard, as used herein, the terms “cabinet,” “housing,” and the like are generally intended to refer to an outer frame or support structure for oven appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of oven appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along vertical direction V, between a first side 108 (e.g., the left side when viewed from the front as in FIG. 1) and a second side 110 (e.g., the right side when viewed from the front as in FIG. 1) along lateral direction L, and between a front 112 and a rear 114 along transverse direction T.

Oven appliance 100 includes an internal cooking chamber 116 disposed or defined within cabinet 102. Cooking chamber 116 may be insulated. In some embodiments, cooking chamber 116 is configured for the receipt of one or more items to be cooked, including food items. Cabinet 102 defines cooking chamber 116 between a top wall 130 and a bottom wall 132. Oven appliance 100 includes a door 120 rotatably mounted to cabinet 102 (e.g., with a hinge). A handle 118 is mounted to door 120 and assists a user with opening and closing door 120 in order to access cooking chamber 116. For example, a user can pull on handle 118 to open or close door 120 and access cooking chamber 116 through a resultant opening. As would be understood, one or more internal electronic elements are provided to treat articles within the cooking chamber 116. In particular, one or more heating elements (e.g., baking heating elements 178 or broiling heating elements 182) may be provided in thermal communication with (e.g., within or in convective thermal communication with) cooking chamber 116 to cook or otherwise heat items therein.

It is noted that although FIGS. 1 and 2 provide an exemplary oven appliance 100. One of ordinary skill would recognize that aspects of the present disclosure may be equally applicable to another suitable domestic appliance; such as a microwave appliance, washing machine appliance, dryer appliance, or dishwashing appliance; which defines a treatment chamber (e.g., cooking chamber, wash chamber, or dry chamber) for treating articles therein (e.g., for cooking or heating, for washing, or for drying). As would be understood, one or more sensing elements (e.g., image sensors, temperature sensors, pressure sensors, humidity sensors, etc.) and electronic elements (e.g., heating elements, pumps, motors, fans, etc.) may be provided for collecting data regarding articles within the treatment chamber or treating articles therein. Thus, except as otherwise indicated, the present disclosure is not limited to any particular domestic appliance or embodiment thereof.

Returning generally to FIGS. 1 and 2, oven appliance 100 can include a seal 122 (e.g., gasket) between door 120 and cabinet 102 that assists with maintaining heat and cooking fumes within cooking chamber 116 when door 120 is closed as shown. Door 120 may include a window 124, constructed for example from multiple parallel glass panes (e.g., glass panels 238, 240) to provide for viewing contents of cooking chamber 116 when door 120 is closed and assist with insulating cooking chamber 116. A baking rack 126 may be positioned in cooking chamber 116 for the receipt of food items or utensils containing food items. Baking rack 126 may be slidably received onto embossed ribs 128 or sliding rails such that baking rack 126 may be conveniently moved into and out of cooking chamber 116 when door 120 is open.

Generally, various sidewalls define cooking chamber 116. For example, cooking chamber 116 includes a top wall 130 and a bottom wall 132 that are spaced apart along vertical direction V. Left and right sidewalls extend between top wall 130 and bottom wall 132, and are spaced apart along lateral direction L. A rear wall 134 may additionally extend between top wall 130 and bottom wall 132 as well as between the left and right sidewalls, and is spaced apart from door 120 along transverse direction T.

In some examples, top 104 includes a front panel 156 or cooktop panel 158. Front panel 156 may be located transversely forward of cooktop panel 158. Front panel 156 may house a controller 162 or controls 164, as described in more detail below. Additionally or alternatively, cooktop panel 158 may be proximal to a plurality of heating assemblies 166, as described in more detail below.

A lower heating assembly (e.g., bake heating assembly 176) may be positioned in oven appliance 100, and may include one or more heating elements (e.g., bake heating elements 178). Bake heating elements 178 may be disposed within cooking chamber 116, such as adjacent bottom wall 132. In exemplary embodiments as illustrated, bake heating elements 178 are electric heating elements, as is generally understood. Alternatively, bake heating elements 178 may be gas burners or other suitable heating elements having other suitable heating sources and which may be electronically controlled (e.g., via a controller 162). Bake heating elements 178 may generally be used to heat cooking chamber 116 for both cooking and cleaning of oven appliance 100.

Additionally or alternatively, an upper heating assembly (e.g., broil heating assembly 180) may be positioned in oven appliance 100, and may include one or more upper heating elements (e.g., broil heating elements 182). Broil heating elements 182 may be disposed within cooking chamber 116, such as adjacent top wall 130. In exemplary embodiments as illustrated, broil heating elements 182 are electric heating elements, as is generally understood. Alternatively, broil heating elements 182 may be gas burners or other suitable heating elements having other suitable heating sources and which may be electronically controlled (e.g., via a controller 162). Broil heating elements 182 may additionally be used to heat cooking chamber 116 for both cooking and cleaning of oven appliance 100.

In some embodiments, oven appliance 100 includes a cooktop 186 positioned at cooktop panel 158 of oven appliance 100. In such embodiments, cooktop panel 158 may be a generally planar member having an upward surface that is perpendicular to vertical direction V. In particular, cooktop panel 158 may be formed from glass, glass ceramic, metal, or another suitable material. A plurality of heating assemblies (e.g., cooktop heating assemblies 166) may be mounted to or otherwise positioned on cooktop panel 158. In some embodiments, cooktop heating assemblies 166 are positioned above cooking chamber 116 of cabinet 102 (i.e., higher relative to vertical direction V). Optionally, cooktop heating assemblies 166 may extend between cooking chamber 116 and cooktop panel 158, within an open region that is defined between cooktop panel 158 and cooking chamber 116. Cooking utensils, such as pots, pans, griddles, etc., may be placed on cooktop panel 158 and heated with heating assemblies 166 during operation of cooktop 186. In FIGS. 1 and 2, cooktop heating assemblies 166 are shown as radiant heating elements mounted below cooktop panel 158. However, in alternative example embodiments, cooktop heating assemblies 166 may be any suitable heating assembly, such as gas burner elements, resistive heating elements, induction heating elements, or other suitable heating elements which may be electronically controlled (e.g., via a controller 162).

Door 120 is mounted on cabinet 102 below cooktop panel 158 to selectively allow access to cooking chamber 116. As may be seen in FIG. 2, door 120 extends between a top lip 192 and a bottom lip 194 (e.g., along vertical direction V when door 120 is in the closed position). Door 120 may further extend between a front surface 196 and a rear surface 198 (e.g., along transverse direction T when door 120 is in the closed position). Handle 118 may be provided on door 120 proximal to top lip 192.

In some embodiments, oven appliance 100 includes a drawer 168 movably mounted to cabinet 102. For instance, drawer 168 may be slidably mounted to cabinet 102 to selectively move forward/rearward along transverse direction T. One or more slidable rails, bearings, or assemblies 170 may be installed or mounted between drawer 168 and cabinet 102 to facilitate movement of drawer 168 relative to cabinet 102, as would be understood. As shown, drawer 168 may be disposed generally below cooking chamber 116. In particular, drawer 168 may be disposed below door 120.

Oven appliance 100 is further equipped with a controller 162 to regulate operation of oven appliance 100. For example, controller 162 may regulate the operation of oven appliance 100, including activation of heating elements (e.g., baking heating elements 178, broiling heating elements 180) as well as heating assemblies 166, 176, 180 generally. Controller 162 may be in operable communication (e.g., via a suitable electronic wired connection) with the heating elements and other components (e.g., electronic elements) of oven appliance 100, as discussed herein. In general, controller 162 may be operable to configure oven appliance 100 (and various components thereof) for cooking. Such configuration may be based on a plurality of cooking factors of a selected operating cycles, sensor feedback, etc.

By way of example, controller 162 may include one or more memory devices (e.g., non-transitive media) and one or more microprocessors, such as general or special purpose microprocessors operable to execute programming instructions or micro-control code associated with an operating cycle. The memory may represent random access memory such as DRAM or read only memory such as ROM or FLASH. In exemplary embodiments, the processor executes programming instructions stored in memory. The memory may be a separate component from the processor or may be included onboard within the processor.

Controller 162 may be positioned in a variety of locations throughout oven appliance 100. For instance, controller 162 may be located within a user interface or control panel 160 of oven appliance 100, as shown in FIG. 2. In some such embodiments, input/output (“I/O”) signals may be routed between the control system and various operational components of oven appliance 100 along wiring harnesses that may be routed through cabinet 102. In some embodiments, controller 162 is in operable communication (e.g., electronic or wireless communication) with user interface panel 160 and controls 164, through which a user may select various operational features and modes and monitor progress of oven appliance 100. In optional embodiments, user interface panel 160 may represent a general purpose I/O (“GPIO”) device or functional block. In certain embodiments, user interface panel 160 includes input components or controls 164, such as one or more of a variety of electrical, mechanical, or electro-mechanical input devices including rotary dials, push buttons, and touch pads. Additionally or alternatively, user interface panel 160 may include a display component, such as a digital or analog display device designed to provide operational feedback to a user (e.g., regarding predicted cook times). User interface panel 160 may be in operable communication with controller 162 via one or more signal lines or shared communication busses.

Furthermore, the user interface panel 160 is located within convenient reach of a user of appliance. User interface panel 160 includes various input components, such as one or more of a variety of touch-type controls 164, electrical, mechanical, or electro-mechanical input devices including knobs, rotary dials, push buttons, and touch pads. The user interface panel 160 may include a display component, such as a digital or analog display device, designed to provide operational feedback to a user.

Various appliance features of appliance may be activated/deactivated by a user manipulating the input components on user interface panel 160. Thus, for example, when appliance is a cooktop or oven appliance 100, a user may manipulate knobs or buttons on user interface panel 160 to activate and deactivate heating elements of appliance 100. As another example, a user of appliance may set a timer on user interface panel 160.

In certain embodiments, one or more sensing elements are mounted to cabinet in operable communication with controller 162 (e.g., to detect or sense one or more conditions within cooking chamber 116 that can be communicated as sensor signals to/from controller 162). Such sensing elements may include or be provided as image sensors (e.g., cameras), temperature sensors (e.g., thermistors or thermocouples), pressure sensors (e.g., piezoelectric pressure sensors), humidity sensors (e.g., electronic psychometer), or one or more other suitable electronic sensors that are secured (e.g., directly or indirectly) to cabinet 102. In optional embodiments, the sensing elements include a discrete interior camera assembly 190 secured (e.g., directly or indirectly) to cabinet 102 and be in operable communication with controller 162 to capture images (e.g., static images or dynamic video) of a portion of oven appliance 100 (e.g., within cooking chamber 116). Thus, sensor signals generated by and communicated from the camera assembly 190 may include or be provided as image signals.

Generally, interior camera assembly 190 may be any type of device suitable for capturing a picture or video. As an example, interior camera assembly 190 may be a video camera or a digital camera with an electronic image sensor [e.g., a charge coupled device (CCD) or a CMOS sensor]. Interior camera assembly 190 may be in operable communication with controller 162 such that controller 162 can receive an image signal (e.g., video signal) from interior camera assembly 190 corresponding to the image(s) captured by interior camera assembly 190. Once received by controller 162, the image signal (e.g., video signal) may be further processed at controller 162 or transmitted to a separate device (e.g., remote server 304) “live” or in real-time for remote viewing (e.g., via a user or remote device 308). Optionally, one or more lights may be included with camera assembly 190 or elsewhere within chamber 116 to illuminate the cooking zone or chamber 116 generally, as would be understood.

As shown, interior camera assembly 190 may be secured to cabinet 102 (e.g., directly or indirectly). In some embodiments, interior camera assembly 190 is directed at a portion of cooking chamber 116. For instance, interior camera assembly 190 may be mounted to door 120 (e.g., at an interior surface thereof) to capture the cooking zone defined by one or more racks 126 within cooking chamber 116, as shown. Alternatively, though, interior camera assembly 190 may be mounted to another suitable structure, such as the top wall 130 of cabinet 102, wherein the camera assembly 190 directed downward.

As would be understood, rack 126 may be positioned (e.g., slidably positioned) in cooking chamber 116 to define a cooking zone for receipt of food items or cooking utensils 136. When assembled, interior camera assembly 190 may thus capture light emitted or reflected from the cooking zone through the cooking chamber 116. In some such embodiments, interior camera assembly 190 can selectively capture an image covering all or some of the horizontal support surface define by rack 126. Optionally, interior camera assembly 190 may be directed such that a line of sight is defined from interior camera assembly 190 that is non-parallel to the horizontal support surface define by rack 126. Thus, the real-time video feed may include a digital picture or representation of the cooking zone or utensil 136.

During use, objects (e.g., cooking utensil 136) placed on one of the rack 126 (or otherwise between the cooking zone and interior camera assembly 190) may be captured (e.g., as a video feed or series of sequential static images) and transmitted to another portion of the oven appliance 100 (e.g., controller 162), as is generally understood. Subsequently, such images may be transmitted or communicated to another device, as will be described below. Moreover, from the captured images, one or more states of utensil or food item may be predicted (e.g., by a separate device). For instance, the captured color, reflectivity, size, or shape of a food item may be used to determine a predicted state (e.g., state of doneness relative to a desired state, such as designated by a particular temperature or label accorded to a particular food item, such as: uncooked, appropriately cooked, overcooked, rare, medium rare, medium, medium well, or well done). As would be understood, detecting or identifying such states, may be performed by one or more suitable image analysis algorithms (e.g., executed at a remote server 304 based on one or more captured images from camera 190).

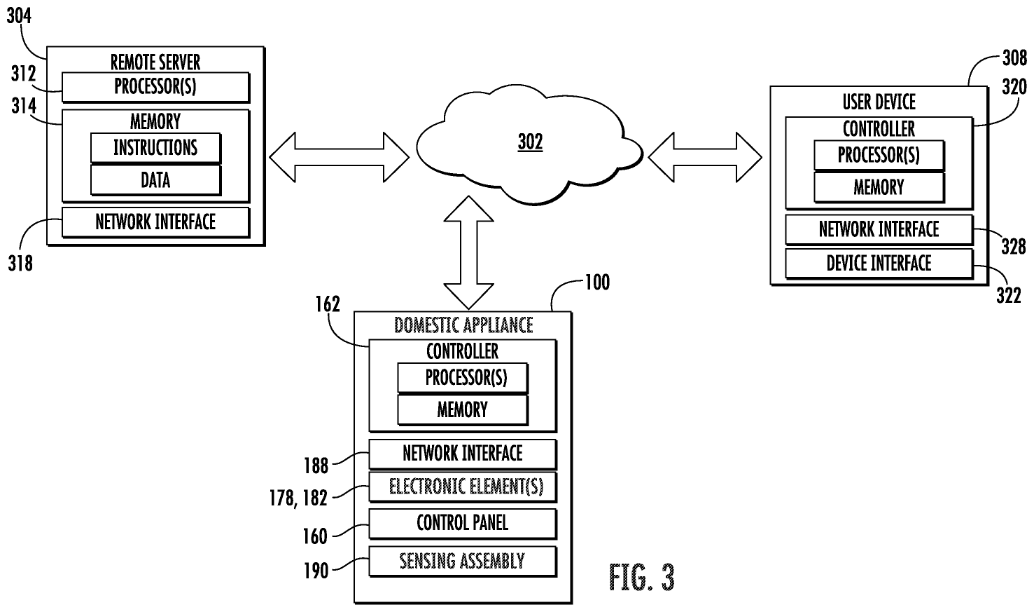

Turning especially to FIG. 3, a schematic view is provided of a system, illustrating a domestic appliance 100 (e.g., cooking appliance 100-FIGS. 1 and 2), one or more remote servers 304, and one or more user devices 308. As shown, cooking appliance 100 can be communicatively coupled with a network 302 and various other nodes, such as a remote server 304 and a user device 308.

In some embodiments, controller 162 includes a network interface 188 such that controller 162 can connect to and communicate over one or more networks (e.g., network 302) with one or more network nodes. Controller 162 can also include one or more transmitting, receiving, or transceiving components for transmitting/receiving communications with other devices communicatively coupled with cooking appliance 100. Additionally or alternatively, one or more transmitting, receiving, or transceiving components can be located off board controller 162.

Network 302 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 302 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, a remote server 304, such as a web server, is in operative communication with cooking appliance 100. The server 304 can be used to host an information database (e.g., image database, user database, etc.). The server 304 can be implemented using any suitable computing device(s). The server 304 may include one or more processors 312 and one or more memory devices 314 (i.e., memory). The one or more processors 312 can be any suitable processing device (e.g., a processor core, a microprocessor, an ASIC, a FPGA, a microcontroller, etc.) and can be one processor or a plurality of processors that are operatively connected. The memory device 314 can include one or more non-transitory computer-readable storage mediums, such as RAM, ROM, EEPROM, EPROM, flash memory devices, magnetic disks, etc., and combinations thereof. The memory devices 314 can store data and instructions which are executed by the processor 312 to cause remote server 304 to perform operations. For example, instructions could be instructions for receiving/transmitting images or image signals, analyzing image signals, transmitting/receiving alert signals, etc.

As an example, the processor 312 and memory 314 may be configured to predict the state of a food item captured in one or more images at the appliance 100. The predicted state (e.g., relative doneness or cook state) may be based, at least in part, an analysis for color, reflectivity, size, shape, or other visible characteristics of the food item captured in one or more images of the image capture sequence. For instance, visible color, reflectivity, size, shape (e.g., including variations thereof over time) may correspond to particular food items or states thereof, including the type of food item, mass, temperature, etc. Such a correspondence or correlation between visible characteristics and detected states may be cataloged or stored within one or more databases (e.g., as a lookup table, chart, formula, etc.).

The memory devices 314 may also include data, such as image data, video data, historical use data, etc., that can be retrieved, manipulated, created, or stored by processor 312. The data can be stored in one or more databases. The one or more databases can be connected to remote server 304 by a high bandwidth LAN or WAN, or can also be connected to remote server 304 through network 302. The one or more databases can be split up so that they are located in multiple locales.

Remote server 304 includes a network interface 318 such that remote server 304 can connect to and communicate over one or more networks (e.g., network 302) with one or more network nodes. Network interface 318 can be an onboard component or it can be a separate, off board component. In turn, remote server 304 can exchange data with one or more nodes over the network 302. In particular, remote server 304 can exchange data with cooking appliance 100 or user device 308. Although not pictured, it is understood that remote server 304 may further exchange data with any number of client devices over the network 302. The client devices can be any suitable type of computing device, such as a general purpose computer, special purpose computer, laptop, desktop, integrated circuit, mobile device, smartphone, tablet, or other suitable computing device.

In certain embodiments, a user device 308 is communicatively coupled with network 302 such that user device 308 can communicate with cooking appliance 100. For instance, user device 308 can communicate directly with cooking appliance 100 via network 302. Alternatively, a user can communicate indirectly with cooking appliance 100 by communicating via network 302 with remote server 304 (e.g., directly or indirectly through one or more intermediate remote servers), which in turn communicates with cooking appliance 100 via network 302. Moreover, a user can be in operative communication with user device 308 such that the user can communicate with cooking appliance 100 via user device 308.

User device 308 can be any type of remote device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 308 can include one or more user device controllers 320. Controller 320 can include one or more processors and one or more memory devices. The one or more processors can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and instructions which are executed by the processor to cause user device 308 to perform operations. Controller 320 a user device network interface 328 such that user device 308 can connect to and communicate over one or more networks (e.g., network 302) with one or more network nodes. Network interface 328 can be an onboard component of controller 320 or it can be a separate, off board component. Controller 320 can also include one or more transmitting, receiving, or transceiving components for transmitting/receiving communications with other devices communicatively coupled with user device 308. Additionally or alternatively, one or more transmitting, receiving, or transceiving components can be located off board controller 320.

User device 308 includes a device interface 322 having one or more user inputs such as, for example, buttons, one or more cameras, or a monitor configured to display graphical user interfaces or other visual representations to user. For example, the device interface 322 can include a display that can present or display graphical user interfaces corresponding to operational features of cooking appliance 100 such that user may manipulate or select the features to operate cooking appliance 100. The display of user device 308 can be a touch sensitive component (e.g., a touch-sensitive display screen or a touch pad) that is sensitive to the touch of a user input object (e.g., a finger or a stylus). For example, a user may touch the display with his or her finger and type in a series of numbers on the display. In addition, motion of the user input object relative to the display can enable user to provide input to user device 308. User device 308 may provide other suitable methods for providing input to user device 308 as well. Moreover, user device 308 can include one or more speakers, one or more cameras, or more than one microphones such that user device 308 is configured with voice control, motion detection, and other functionality.

Generally, a user may be in operative communication with cooking appliance 100 or one or more user devices 308. For instance, a user may wish to alternately operate cooking appliance 100 directly (e.g., through control panel 160) or remotely (e.g., through user device 308). In particular, a user may wish to control operational features that include activating portions of cooking appliance 100, selecting a temperature or heat setting for cooking appliance 100, or receiving one or more alert signals or messages relating to oven appliance 100.

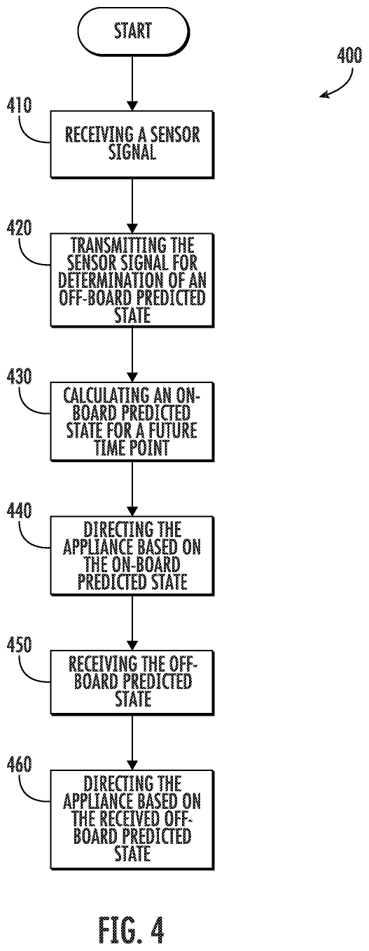

Referring now to FIG. 4, various methods may be provided for use with a domestic appliance, such as oven appliance 100 (FIG. 1), in accordance with the present disclosure. In general, the various steps of methods as disclosed herein may, in exemplary embodiments, be performed by a controller (e.g., controller 162 or remote server 304) as part of an operation that the controller is configured to initiate or direct (e.g., a directed cooking operation). During such methods, the controller may receive inputs and transmit outputs from various components of the oven appliance 100. For example, the controller may send signals to and receive signals from remote server 304, camera assembly 190, control panel 160, or user device 308. In particular, the present disclosure is further directed to methods, as indicated by 400, for operating a domestic appliance.

Such methods advantageously facilitate adaptive use (e.g., cooking) that is responsive to conditions at the particular appliance executing the operation—at least in part. Moreover, such methods may advantageously be capable of addressing or accounting for lag in communications with a remote device (e.g., while still being able to make use of the increased accuracy or other benefits offered use of the remote device, such as for advanced off-board calculations or algorithms). Data handling, overall analysis, or responsiveness of the system may further be improved.

FIG. 4 depicts steps performed in a particular order for purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At 410, the method 400 includes receiving a sensor signal from the sensing element. Such sensor signals may be received, for instance, from a sensing element within the appliance during an appliance operation, such as a cooking operation in the case of an oven appliance. Thus, prior to or as part of 410, the method 400 may include initiating an appliance (e.g., cooking) operation. For instance, a user may activate one or more heating elements or otherwise direct the oven appliance to heat the cooking chamber, such as by selecting a mode of heating or temperature to which the cooking chamber or food item is to be heated (e.g., relative doneness of a food item selected at or otherwise received from the control panel of the appliance or at a user device). Thus, 410 may include receiving an activation signal to activate one or more heating elements in thermal communication with the cooking chamber, as would be understood.

In some embodiments, the sensing element comprises a camera or camera assembly, as described above. In turn, the sensor signal may include an image signal (e.g., an item within the treatment or cooking chamber). Thus, 410 may include receiving an image signal from a camera assembly. For instance, the image signal may be received from a camera assembly directed at (or otherwise adjacent to) the treatment or cooking chamber of the cooking appliance (e.g., as described above). Moreover, the camera assembly may be directed toward the cooking zone such that a rack is within the line of sight of the camera assembly (e.g., to capture portion of the rack, which may receive a cooking utensil or food item thereon). Thus, the image signal may generally correspond to a portion of the cooking chamber and any cooking utensil or food item therein. As would be understood, the image signal may include multiple sequenced images captured by the camera assembly.

Generally, sensor signal may be received in response to a capture sequence (e.g., image capture sequence) initiated at the sensing element. The capture sequence may be initiated, for instance, following initiation of the appliance operation. As an example, 410 may be in response to receiving the activation signal of one or more electronic elements within the cabinet. Additionally or alternatively, the capture sequence may be initiated in response to a triggering event (e.g., detected opening or closing of the door to the treatment or cooking chamber). In some embodiments, an image signal may be captured and transmitted by specific user input supplied to a user interface of the cooking appliance (e.g., at the control panel or user device). During the image capture sequence, a first image may be captured that includes a particular food item (e.g., placed on the rack of the cooking appliance or otherwise within the line of sight of the camera assembly). The first image may then be included with the image signal transmitted at 420 (e.g., for further analysis at a remote device, such as the remote server).

At 420, the method 400 includes transmitting the sensor signal from the controller of the appliance for determination of an off-board predicted state of the domestic appliance. For instance, the sensor or image signal may be transmitted by the appliance controller (e.g., wirelessly through the network) to a remote server.

At the remote server, the sensor signal may be evaluated according to one or more complex, machine learning, or artificial intelligence algorithms (e.g., as part of the method 400 following 420). In some embodiments, the off-board predicted state of the domestic appliance (e.g., the state of items or articles within the treatment chamber, such as the relative doneness of a food item, relative cleanliness of an article being washed, or relative dryness of an article being dried) may be estimated via image analysis at the remote device or server.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor the cooking utensil. It should be appreciated that this image analysis or processing may be performed locally (e.g., by the appliance controller) or remotely (e.g., by offloading image data to the remote server or network).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities or differences between the reference image and the obtained image may be used to extract useful information for improving appliance performance.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects (e.g., including their relative treatment state), such as edge matching or detection, divide-and-conquer searching, greyscale matching, histograms of receptive field responses, or another suitable routine (e.g., executed at the appliance controller based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models.

It should be appreciated that image processing and machine learning image recognition processes may be used together to facilitate improved image analysis, object detection, estimation of a treatment state, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

At 430, the method 400 includes calculating, at the domestic appliance, an on-board predicted state for a future time point, the future time point. In other words, on the controller of the appliance, a particular predicted state (e.g., relative to a projected progression curve or path) may be calculated at some particular point of time in the future. Thus, it may be determined what the predicted state of the item (e.g., food item) within the treatment chamber will be at the particular point of time in the future (i.e., future time point).

Generally, the calculation at 430 may use any suitable forecasting algorithm or equation. For instance, the forecasting algorithm or equation used at 420 may calculate the predicted state as a point along a set timeline. The set timeline may be, as an example, a timeline or model for a cooking operation (e.g., from start to the achievement of a desired internal food temperature or doneness level). The calculation may receive the most recent previously predicted state of the item (e.g., received from the remote device or 0, such as if no previously predicted state has been received) and the future time point as inputs and provide the predicted state as an output. In some such embodiments, the forecasting algorithm includes an exponential smoothing (i.e., error, trend, and seasonality or “ETS”) algorithm, which is generally understood in the art. Nonetheless, additional or alternative embodiments may include other forecasting algorithms, such as for extrapolation.

The future time point may be measured, for instance, in seconds, minutes, or some other incremental interval along the set timeline (e.g., an incremental count of the number of inferences received). The future time point may be based on (e.g., include or be provided as) a communication lag interval. Generally, the communication lag interval may represent the amount of time expected between when sensor signal is detected (e.g., at 410) and when an off-board predicted state based on that sensor signal may be received.

In some embodiments, the lag interval includes or is provided as a set value (e.g., programmed during assembly or based on historical data acquired independently of the appliance). Such a set value may be a programmed default or fixed value that is uninfluenced by the historical performance of the appliance.

In additional or alternative embodiments, the lag interval is determined or calculated (e.g., on the appliance) prior to 410. For instance, the lag interval may be based on a plurality of previous intervals (e.g., historical data detected or recorded over time, such as during past operations of the appliance). In some such embodiments, the plurality of previous intervals are each collected at the oven appliance as a discrete detected interval between transmitting a previous sensor signal and receiving a previous corresponding off-board predicted state of the appliance. Thus, historical data regarding the amount of lag between when sensor signal is detected (e.g., at 410) and when an off-board predicted state based on that sensor signal may be used. Optionally, the historical data may include every model prediction (e.g., detected lags) up to the point of 430 or, alternatively, only a fixed number of model predictions (e.g., the most recent X lags). In optional embodiments, calculating the lag interval further includes calculating a mean interval value based on the plurality of previous intervals.

In further additional or alternative embodiments, the lag interval is determined or calculated (e.g., on the appliance) during the operation of the method 400. The lag interval may include an initial interval and a variable interval. The lag interval may be determined, for instance, by measuring the elapsed time between transmission of a first-in-time sensor signal (e.g., image signal) of the operation and receipt of corresponding off-board predicted state. The variable lag interval may be based on the temporal gap between number of sensor signals that are transmitted (e.g., previous instances of 410 during the method 400) and the signal to which the most-recently received off-board predicted state corresponds. Thus, in some embodiments, the variable lag is based on the number of images captured versus how far behind the most recent image the most-recently received off-board predicted state (e.g., inference) is based on. As a specific illustrative example, if the current captured image is #100 and the last received inference is for image #95, the difference between the images is 5. If an image is captured at a set interval of once every 2 seconds, the variable lag is (100−95)*2 seconds (i.e., 10 seconds). If the first inference was received 40 seconds after the first image was captured, the lag interval would be or include 40 seconds+10 seconds (i.e., 50 seconds). Therefore, the target time to predict for the system when the 95th image inference received is 50 seconds ahead.

In optional embodiments, the lag interval includes an interval threshold (e.g., set value or based on a historical value, as described above). If a calculated lag interval exceeds the interval threshold, the lag interval may be reduced by a set amount (e.g., interval reduction factor) or, alternatively, to a set value (e.g., interval floor). Thus, a comparison of the calculated interval may be made to the interval threshold. In response, to a determination that the calculated lag interval exceeds the interval threshold, the calculated lag interval may be reduced (e.g., by an interval reduction factor) or replaced (e.g., by an interval floor) to determine a new value for the lag interval.

Once the lag interval is determined, the on-board predicted state may be determined or calculated, as described above. For instance, the relative doneness of the food item may be determined as a value between a minimum value (e.g., 0 or completely uncooked) and a maximum value (e.g., 180 or completely cooked) along the timeline or model used at 430. If a previous predicted state has been obtained (e.g., for the food item), the on-board predicted state may update or replace that previous predicted state. In some embodiments, the on-board predicted state includes an updated, unfinished or uncooked state. In alternative embodiments, the on-board predicted state includes a completed or completely cooked state.

At 440, the method 400 includes directing the appliance based on the on-board predicted state. For instance, one or more electronic elements (e.g., heating elements) may be adjusted according to the on-board predicted state. Optionally, the heating elements may be adjusted (e.g., to increase, decrease, or maintain heat output) based on the on-board predicted state. As an example, upon or in response to determining an on-board predicted state that includes an uncooked state (e.g., not completely cooked), heat output at the heating elements may be maintained (e.g., at its current level). As another example, upon or in response to determining an on-board predicted state that includes a completely cooked state, heat output at the heating elements may be reduced or halted. In other words, 440 may include reducing a heat output at the heating element according to the on-board predicted state (e.g., being or including a completely cooked state).

Separate from or in addition to adjusting electronic elements, 440 may include updating a variable operation countdown. Such countdowns are generally known (e.g., as an estimated time until the corresponding operation will be completed) and can be displayed, for instance, on the user interface panel of the appliance or the display of a remote device. In some embodiments, the variable operation countdown can be updated according to the on-board predicted state for the future time point. As an example, upon or in response to determining an on-board predicted state that includes an uncooked state (e.g., not completely cooked), the operation countdown may be adjusted (e.g., increased or decreased) from the previously displayed value for a new value that corresponds to the on-board predicted state. Thus, the countdown may be increased if the on-board predicted state is less progressed (e.g., less cooked) than would be expected based solely on a previous value or prediction. Alternatively, the countdown may be decreased if the on-board predicted state is more progressed (e.g., more cooked) than would be expected based solely on a previous value or prediction. As another example, upon or in response to determining an on-board predicted state that includes a completely cooked state, the operation countdown may be halted. Additionally or alternatively, an alarm (e.g., audio or visual alarm) may be initiated (e.g., as is generally understood) to indicate the appliance operation (or a portion thereof) is complete.

At 450, the method 400 includes receiving the off-board predicted state following 440. For instance, if the operation is not otherwise halted at 440, the off-board predicted state may be received at 450. The off-board predicted state of 450 may be determined as described above and be based on or correspond to one or more transmitted sensor signals (e.g., the sensor signal at 410).

At 460, the method 400 includes directing the appliance based on the received off-board predicted state. For instance, the off-board predicted state of 450 may update or replace the on-board predicted state of 430 and 440. In some embodiments, the off-board predicted state includes an updated, unfinished or uncooked state. In alternative embodiments, the off-board predicted state includes a completed or completely cooked state. At 460, the appliance may be directed similarly to the manner described above.

For instance, one or more electronic elements (e.g., heating elements) may be adjusted according to the off-board predicted state. Optionally, the heating elements may be adjusted (e.g., to increase, decrease, or maintain heat output) based on the off-board predicted state. As an example, upon or in response to determining an off-board predicted state that includes an uncooked state (e.g., not completely cooked), heat output at the heating elements may be maintained (e.g., at its current level). As another example, upon or in response to determining an off-board predicted state that includes a completely cooked state, heat output at the heating elements may be reduced or halted. In other words, 440 may include reducing a heat output at the heating element according to the off-board predicted state (e.g., being or including a completely cooked state).

Separate from or in addition to adjusting electronic elements, 440 may include updating the variable operation countdown. As an example, upon or in response to determining an off-board predicted state that includes an uncooked state (e.g., not completely cooked), the operation countdown may be adjusted (e.g., increased or decreased) from the previously displayed value for a new value that corresponds to the off-board predicted state. Thus, the countdown may be increased if the off-board predicted state is less progressed (e.g., less cooked) than would be expected based solely on a previous value or prediction. Alternatively, the countdown may be decreased if the off-board predicted state is more progressed (e.g., more cooked) than would be expected based solely on a previous value or prediction. As another example, upon or in response to determining an off-board predicted state that includes a completely cooked state, the operation countdown may be halted. Additionally or alternatively, an alarm (e.g., audio or visual alarm) may be initiated (e.g., as is generally understood) to indicate the appliance operation (or a portion thereof) is complete.

Following 460, one or more of the above steps may be repeated. For instance, the method 400 may return to 410 (e.g., assuming the operation has not been halted) for repeated sensor detection or image capture and further adjustments to operation of the electronic elements (e.g., in comparison to 460) based on new on-board predicted states and new future time points. Thus, the method 400 may continuously update the cooking operation based on current conditions, the latest received off-board predicted state, or the latest on-board predicted state.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance comprising:
a cabinet defining a cooking chamber;
a heating element in thermal communication with the cooking chamber to heat a cooking utensil therein;
a sensing element mounted to the cabinet; and
a controller in operable communication with the heating element and the sensing element, the controller being configured to direct a cooking operation comprising
receiving a sensor signal from the sensing element,
transmitting the sensor signal from the controller for determination of an off-board predicted state of the oven appliance,
calculating, at the oven appliance, an on-board predicted state for a future time point, the future time point being based on a communication lag interval, and
directing the oven appliance based on the on-board predicted state.

2. The oven appliance of claim 1, wherein the sensing element comprises a camera directed at the cooking chamber, and wherein the sensor signal comprises an image signal.

3. The oven appliance of claim 1, wherein the communication lag interval comprises a set value.

4. The oven appliance of claim 1, wherein the cooking operation further comprises
determining the communication lag interval prior to transmitting the sensor signal, determining the communication lag interval comprises evaluating a plurality of previous intervals, the plurality of previous intervals each being collected at the oven appliance as detected intervals between transmitting a previous sensor signal and receiving a previous off-board predicted state of the oven appliance.

5. The oven appliance of claim 1, wherein directing the oven appliance comprises reducing a heat output at the heating element according to the on-board predicted state.

6. The oven appliance of claim 1, further comprising:
a user interface panel mounted to the cabinet, and
wherein directing the oven appliance comprises updating a variable operation countdown displayed at the user interface panel according to the on-board predicted state for the future time point.

7. The oven appliance of claim 1, wherein the cooking operation further comprises
receiving the off-board predicted state of the oven appliance from a remote device following directing the oven appliance based on the on-board predicted state, and
directing the oven appliance based on the received off-board predicted state.

8. A method of operating an oven appliance comprising a cabinet defining a cooking chamber, a user interface panel mounted to the cabinet, a heating element in thermal communication with the cooking chamber, and a sensing element mounted to the cabinet, the method comprising:
receiving a sensor signal from the sensing element;
transmitting the sensor signal from the oven appliance for determination of an off-board predicted state of the oven appliance;
calculating, at the oven appliance, an on-board predicted state for a future time point, the future time point being based on a communication lag interval; and
directing the oven appliance at the user interface panel or the heating element based on the on-board predicted state.

9. The method of claim 8, wherein the sensing element comprises a camera directed at the cooking chamber, and wherein the sensor signal comprises an image signal.

10. The method of claim 8, wherein the communication lag interval comprises a set value.

11. The method of claim 8, further comprising:
determining the communication lag interval prior to transmitting the sensor signal, determining the communication lag interval comprises evaluating a plurality of previous intervals, the plurality of previous intervals each being collected at the oven appliance as detected intervals between transmitting a previous sensor signal and receiving a previous off-board predicted state of the oven appliance.

12. The method of claim 8, wherein directing the oven appliance comprises reducing a heat output at the heating element according to the on-board predicted state.

13. The method of claim 8, wherein directing the oven appliance comprises updating a variable operation countdown displayed at the user interface panel according to the on-board predicted state for the future time point.

14. The method of claim 8, further comprising:
receiving the off-board predicted state of the oven appliance from a remote device following directing the oven appliance based on the on-board predicted state; and
directing the oven appliance based on the received off-board predicted state.

15. A method of operating a domestic appliance comprising a cabinet defining a treatment chamber, a user interface panel mounted to the cabinet, an electronic element mounted to the cabinet in operable communication with the treatment chamber, and a sensing element mounted to the cabinet, the method comprising:
receiving a sensor signal from the sensing element;
transmitting the sensor signal from the domestic appliance for determination of an off-board predicted state of the domestic appliance;
calculating, at the domestic appliance, an on-board predicted state for a future time point, the future time point being based on a communication lag interval;
directing the domestic appliance based on the on-board predicted state;
receiving the off-board predicted state of the domestic appliance from a remote device following directing domestic oven appliance based on the on-board predicted state; and
directing the domestic appliance based on the received off-board predicted state.

16. The method of claim 15, wherein the sensing element comprises a camera directed at the treatment chamber, and wherein the sensor signal comprises an image signal.

17. The method of claim 15, wherein the communication lag interval comprises a set value.

18. The method of claim 15, further comprising:
determining the communication lag interval prior to transmitting the sensor signal, determining the communication lag interval comprises evaluating a plurality of previous intervals, the plurality of previous intervals each being collected at the domestic appliance as detected intervals between transmitting a previous sensor signal and receiving a previous off-board predicted state of the domestic appliance.

19. The method of claim 15, wherein directing the domestic appliance comprises
adjusting the treatment chamber at the electronic element according to the on-board predicted state.

20. The method of claim 15, wherein directing the domestic appliance comprises
updating a variable operation countdown displayed at the user interface panel according to the on-board predicted state for the future time point.
